(19) United States
(12) Patent Application Publication
(10) Pub. No.: US 2008/0235170 A1
(43) Pub. Date: Sep. 25, 2008

(54) USING SCENARIO-RELATED METADATA TO DIRECT ADVERTISING

(75) Inventors: Thekkthalackal Varugis Kurien, Sammamish, WA (US); Steven E. Jackson, Issaquah, WA (US); Scott A. Field, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/688,023

(22) Filed: Mar. 19, 2007

(51) Int. Cl. G06F 15/18

(52) U.S. Cl. 706/20

(57) ABSTRACT

Mechanisms for directing advertising in search result presentation and/or scenario solution execution based upon a user's locality are provided. Locality refers to a collection of metadata created based upon scenario solutions executed by a user and/or enablers acquired by a user during scenario solution execution. For instance, embodiments of the present invention provide a mechanism by which scenario solutions or enablers related to commonly executed scenario solutions or enablers stored in association with the user's locality can be advertised to the user in conjunction with presentation of scenario solution-related search results. Additionally, embodiments of the present invention provide a mechanism by which more highly rated scenario solutions and/or enablers than those associated with the user's locality may be advertised during presentation of an executed scenario solution.

### BACKGROUND

Use of online searching as a means to locate desired information has significantly increased in recent years to become one of the most prevalent systems for locating information in use today. Generally, search engines utilize keyword matching to locate information containing identical and/or similar keywords to a search query input by a user. While keyword matching has its advantages over more generic search methods, a significant number of items are often returned in response to a search query, many of which are not related to the core topic intended by the user.

Advancements in keyword search have more recently been directed toward mining search-related data in an attempt to enhance a user's search experience. One specific example of this type of enhancement, that also has a benefit of creating a revenue stream with an increased likelihood of return, is directed advertising. For instance, suppose a user initiates a search containing the keywords “photographs and editing.” In response thereto, a plurality of items is returned to the user as search results, each containing and/or relating to the input keyword. Additionally, one or more advertisements related to “photographs and editing” may be presented to the user.

This type of advertising is directed specifically to the user as it is known that it is at least tangentially related to a topic of interest to the user. However, it still may miss the user's ultimate interest. That is, advertisements related to commercial photography equipment may be returned when what the user is truly interested in is consumer photograph editing.

### BRIEF SUMMARY

Embodiments of the present invention relate to directing advertising in search result presentation based upon a user's locality. “Locality,” as the term is used herein, refers to a collection of metadata created based upon scenario solutions executed by a user and/or enablers acquired by a user during scenario solution execution. For instance, embodiments of the present invention provide a mechanism by which scenario solutions or enablers related to commonly executed scenario solutions or enablers stored in association with the user's locality can be advertised to the user in conjunction with presentation of scenario solution-related search results. Additionally, embodiments of the present invention provide a mechanism by which more highly rated scenario solutions and/or enablers than those currently associated with the user's locality may be advertised during presentation of an executable scenario solution.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary computing system architecture suitable for use in implementing embodiments of the present invention;

FIG. 3 is a flow diagram showing a method for using scenario solution-related information to direct advertising, in accordance with an embodiment of the present invention; and

FIG. 4 is a flow diagram showing a method for using scenario solution-related information to direct advertising, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide methods, systems, and computer-readable media for directing advertising in search result presentation and/or scenario solution execution based upon a user's locality. “Locality,” as the term is used herein, refers to a collection of metadata created based upon scenario solutions executed by a user and/or enablers acquired by a user during scenario solution execution. For instance, embodiments of the present invention provide a mechanism by which scenario solutions or enablers related to commonly executed scenario solutions or enablers stored in association with the user's locality can be advertised to the user in conjunction with presentation of scenario solution-related search results. Additionally, embodiments of the present invention provide a mechanism by which more highly rated scenario solutions and/or enablers than those associated with the user's locality may be advertised during presentation of an executed scenario solution.

Accordingly, in one aspect, the present invention provides one or more computer-readable media having computer-executable instructions embodied thereon that, when executed, perform a method for using scenario solution-related information to direct advertising. The method includes receiving user selection of an executable scenario solution, the executable scenario solution being identified in response to a scenario-related query; analyzing at least one of metadata associated with the selected scenario solution and metadata associated with a user-specific information store; and identifying at least one advertisement to present utilizing the analyzed metadata.

In another aspect, the present invention provides a method for using scenario solution-related information to direct advertising. The method includes receiving user selection of an executable scenario solution, the executable scenario solution being identified in response to a scenario solution-related query; identifying at least one advertisement to present, wherein the at least one advertisement is relevant to at least one user interest; and transmitting the selected scenario solution and the at least one identified advertisement for presentation. In embodiments, the at least one user interest may be evidenced by metadata associated with the selected scenario solution and/or metadata associated with a user-specific store.

In a further aspect, the present invention provides a computerized system for using scenario solution-related information to direct advertising. The computerized system includes an end-user device configured for receiving a scenario-related query, and a server configured for receiving a scenario-related query from the end-user device and for identifying at least one advertisement relevant to a user interest to present. The end-user device and the server are in communication with one another via a network. In embodiments, the server may include a receiving module configured for receiving the scenario-related query from the end-user device; a data mining module configured for mining at least one of metadata associated with an executable scenario solution related to the scenario-related query and metadata associated with a user-specific information store; an advertisement identifying module configured for identifying at least one advertisement to present, wherein the at least one advertisement is identified based upon the mined metadata; and a transmitting module configured for transmitting the executable scenario solution related to the scenario-related query and the identified advertisement for presentation and association with the end-user device.

Having briefly described an overview of embodiments of the present invention, an exemplary operating environment suitable for implementing the present invention is described below.

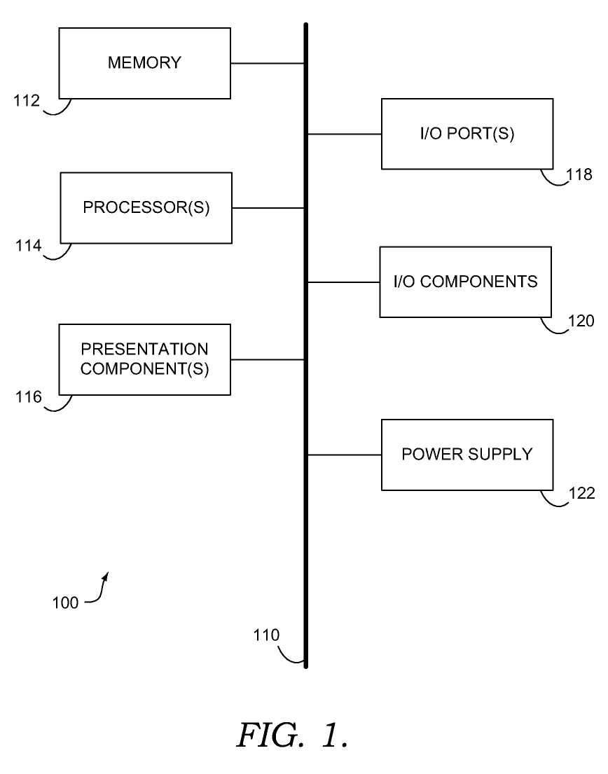

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

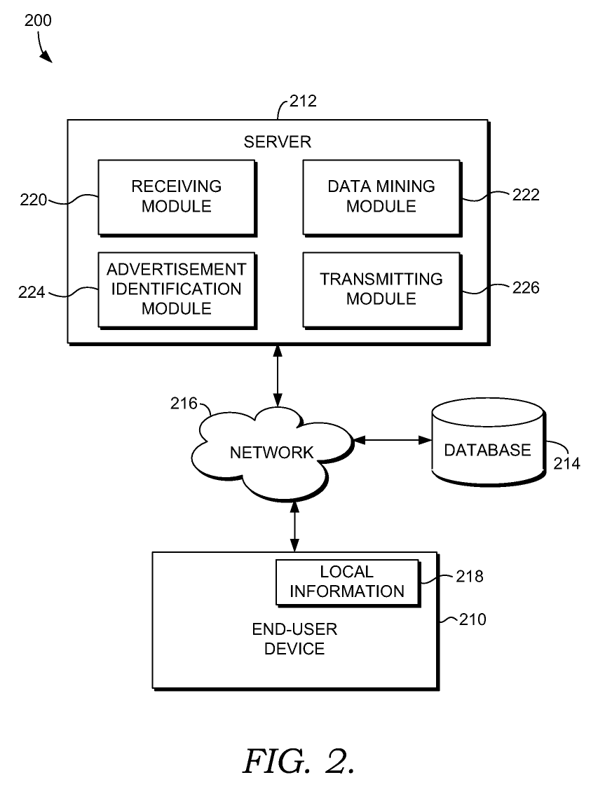

As previously mentioned, in one embodiment, the present invention relates to utilizing scenario solution-related information to direct advertising. With reference to FIG. 2, a block diagram is illustrated that shows an exemplary computing system architecture 200 configured for using scenario solution-related information to direct advertising, in accordance with an embodiment of the present invention. It will be understood and appreciated by those of ordinary skill in the art that the computing system architecture 200 shown in FIG. 2, is merely an example of one suitable computing system and is not intended to suggest any limitation as to the scope of use or functionality of the present invention. Neither should the computing system architecture 200 be interpreted as having any dependency or requirement related to any single component/module or combination of components/modules illustrated therein.

Computing system architecture 200 includes an end-user device 210, a server 212, and a database 214, all in communication with one another via a network 216. The network 216 may include, without limitation, one or more local area networks (LANS) and/or wide area networks (WANs). Such networking environments are commonplace in offices, enterprise-wide computer networks, intranets, and the Internet. Accordingly, the network 216 is not further described herein.

The database 214 is configured to store information associated with at least one executable scenario solution and information associated with at least one advertisement. In various embodiments, such information may include one or more scenario solutions, one or more scenario descriptions, and one or more advertisements. In embodiments, the database 214 is configured to be searchable for one or more of the items stored in association therewith. It will be understood and appreciated by those or ordinary skill in the art that the information stored in the database 214 may be configurable and may include any information relevant to a scenario solution and/or an advertisement. The content and volume of such information are not intended to limit the scope of embodiments of the present invention in any way. Further, though illustrated as a single, independent component, database 214 may, in fact, be a plurality of databases, for instance, a database cluster, portions of which may reside on the end-user device 210, the server 212, another external computing device (not shown), and/or any combination thereof.

Each of the end-user device 210 and the server 212 shown in FIG. 2 may be any type of computing device, such as, for example, computing device 100 described above with reference to FIG. 1. By way of example only and not limitation, each of the end-user device 210 and the server 212 may be a personal computer, desktop computer, laptop computer, handheld device, mobile handset, consumer electronic device, or the like. It should be noted, however, that the present invention is not limited to implementation on such computing devices, but may be implemented on any of a variety of different types of computing devices within the scope of embodiments hereof.

As previously stated, computing system 200 is configured for utilizing scenario-related queries and information associated with user-executable scenario solutions to direct advertising. A scenario-related query may be input by a user much like a standard keyword search query may be input, for instance, in association with an appropriate field presented on a user interface, or the like. However, in accordance with embodiments of the present invention, when a user query is input, it is assumed that the user desires to solve a particular problem, that is, that the user desires to execute a solution to het problem and/or achieve a particular result. Accordingly, each item returned in response to the user query is representative of a particular series of steps implemented by a workflow or an executable “scenario solution” as it is referred to herein.

A scenario solution is typically authored by an individual that is an expert in his or her field, an individual that has a particular interest in a field associated with the scenario solution, and/or an individual that has been confronted with the issue that the scenario purports to address. Scenario solutions are comprised of two scenario entities: a solution and a scenario description. A “solution,” as the term is utilized herein, is essentially a series of steps implemented by a workflow. Often times, scenario solutions are comprised of sub-scenario solutions whose sequential execution (e.g., organized via a requires relation) results in successful completion of the scenario solution end-to-end. Thus, a scenario solution may include any number of scenario sub-solutions associated with one another such that they may be executed in a particular order.

It should be noted that scenario solutions may either be authored from scratch or existing scenario solutions may be located and reused (whether modified or unmodified). Further, authoring a scenario solution may be as simple as recording and replaying a search session or it may be more complex, for instance, by executing search queries in the context of a C++ or Javascript program. Any and all such variations are contemplated to be within the scope of embodiments hereof.

Often, successful completion of a scenario solution requires one or more peripheral objects or enablers. An “enabler,” as the term is utilized herein, may include, for instance, a document, a software/hardware object, and/or a person or organization that freely (or for financial gain) implements a scenario solution. It will be understood and appreciated by those of ordinary skill in the art that the listed enablers are provided by way of example only and that embodiments of the present invention are not so limited. Any object that implements a scenario solution or sub-scenario solution may be considered an enabler within embodiments hereof.

In addition to one or more solutions, scenario solutions include a scenario description. A “scenario description,” as the term is utilized herein, is a webpage that describes an executable scenario solution. Scenario descriptions may be generated by any number of methods including, without limitation, receipt of a description from the scenario solution author, extraction of one or more keywords from the corresponding scenario solution, or the like. It will be understood and appreciated by those of ordinary skill in the art that embodiments of the present invention are not intended to be limited to any particular system or method for generating scenario descriptions. Any number of known description-generating methods may be utilized in accordance with embodiments hereof. Scenario descriptions are typically located by keyword search (the keywords being derived from a scenario-related query) and selectable identifiers thereof are presented in response to a search request, as more fully described below.

Once a scenario solution author completes the authoring of an executable scenario solution, the scenario may be published into one or more namespaces and/or associated with one or more keywords such that it may be searched upon receipt of a scenario-related query, as more fully described below. “Namespaces,” as utilized herein, are used to segment knowledge into verticals and to provide an extensibility point for customized and scenario solution-specific search terms. For instance, the “My Media/My Music” namespace may contain scenario solutions that are music scenario solutions, whereas the “My Life/My Store” namespace may contain information about stores at which a user commonly shops. A namespace provides a meta-data specification relevant to a scenario solution by providing keywords specific to the namespace (similar to search macros). The root namespace defines basic keywords and relations used by the search engine. Namespaces provide a vocabulary for restricting search by defining a schema. For example, the word “format” means something different in the “My Media” namespace than it does in the “Storage” namespace. That is, a namespace defines keywords that can be used in search queries when targeted against that namespace.

When an author publishes a scenario solution, s/he specifies a tag (e.g., a meta-tag) that describes the namespace(s)/keywords(s) in association with which s/he wants to publish the scenario solution. The author is incentivized to apply the appropriate namespace/keyword tag(s) to a published scenario solution so that the search engine may locate it more easily. Systems and methods for publishing information in a network environment so that it may be accessible by other users are known in the art and, accordingly, are not further described herein. Embodiments of the present invention are not limited to any particular publication system/method.

A real or virtual execution environment within which one or more enablers provided by a scenario solution executes is referred to herein as a “scenario solution execution workspace” or “workspace.” Thus, stored in association with a workspace is metadata associated with such enablers. Also stored in association with a workspace are namespace/keyword instances. That is, when a user executes a scenario solution, one or more local instances of the namespace(s)/keyword(s) with which the scenario solution is associated may be created and populated with data, e.g., metadata related to enablers acquired by the user in the context of the executable scenario solution, information related to other scenario solutions stored in association with the namespace/keyword, and the like. Accordingly, a workspace associated with a particular user may define a locality associated with the user.

As shown in FIG. 2, the end-user device 210 includes a local information store 218. The local information store 218 is configured to store information related to one or more scenario solutions of interest to the user and one or more enablers previously acquired by the user, as more fully described herein below. By way of example only, and not limitation, information stored in association with the local information store 218 may include at least one previously executed scenario solution instance, metadata that corresponds to at least one enabler acquired during execution of at least one previously executed scenario solution instance, metadata that corresponds to at least one previously acquired enabler, and any user groups to which the user associated with end-user device 210 is associated. The information stored in association with the local information store 218 may be segregated into a plurality of workspaces, each workspace being associated with the namespace/keyword instances, enabler metadata, and the like relevant thereto. Thus, the local information store 218 is itself a workspace with a plurality of more specific workspaces associated therewith. A user's local information store may also define a locality associated with the user.

In embodiments, the local information store 218 may be utilized to drive results to a scenario-related query. That is, the entire group of scenario solution enabler entities within the local information store 218 itself may constitute a search parameter with all search results containing scenario solutions that the user could accomplish utilizing only what s/he has access to. Another variant is that returned results may include not only the scenario solutions that the user could accomplish utilizing only information stored in association with the local information store 218, but those scenario solutions that could be accomplished if the user were to acquire a defined number of additional scenario solution enabler entities, e.g., no more than two enabler entities. One implementation of this embodiment is a comparison between the enablers that the user already has stored in association with the local information store 218 with enablers needed to execute another scenario solution of higher rank (e.g., based upon a user-community ranking scheme, certification or the like) than a scenario solution for which no enabler acquisition is necessary. It will be understood by those of ordinary skill in the art that the above examples are offered by way of example only and are not intended to limit the scope of embodiments of the present invention in any way.

Returning now to FIG. 2, the server 212 includes a receiving module 220, a data mining module 222, an advertisement identification module 224, and a transmitting module 226. In some embodiments, one or more or the modules 220, 222, 224 and 226 may be implemented as stand-alone applications. In other embodiments, one or more of the modules 220, 222, 224 and 226 may be integrated directly into the operating system of the server 212 or the end-user device 210. It will be understood by those of ordinary skill in the arts that the modules 220, 222, 224 and 226 illustrated in FIG. 2 are exemplary in nature and in number and should not be construed as limiting. Any number of modules may be employed to achieve the desired functionality within the scope of embodiments of the present invention.

The receiving module 220 is configured for receiving scenario-related queries from, e.g., end-user device 210. The receiving module 220 is further configured for receiving metadata that corresponds to a user associated with the end-user device 210. For instance, a user may have one or more enablers stored in association with the end-user device 210 (e.g., in an execution workspace or local information store 218) such that upon execution of a scenario solution requiring such enabler(s), acquisition thereof will not be necessary. Additionally, a user may be a member of a particular user group, for instance, a group of individuals who regularly correspond about a mutual topic of interest. Still further, a user may have personal and/or demographic information published in association with his/her login or identity. Any and all such information to which access has been provided to the search engine, may be received by the receiving module 220 and utilized to direct advertising, as more fully described below.

The data mining module 222 is configured for mining at least one of metadata associated with an executable scenario solution related to the scenario-related query and metadata associated with a user-specific information store, for instance, local information store 218 of FIG. 2, and/or a scenario solution execution workspace. As previously stated, often times, while researching a particular scenario solution, a user may already have a set of enabler entities locally available at their disposal. Thus, data mining module 222 is configured to search the user's local information store 218 for scenario solutions executed by the user (i.e., user-executed scenario solution instances) and scenario solution enablers to which the user has access. This information may be utilized not only to identify one or more scenario solutions that address the scenario-related query, but to identify one or more advertisements for presentation in association therewith, as more fully described below.

The advertisement identification module 224 is configured for identifying a least one advertisement to present, the at least one advertisement being identified based upon the data mined by data mining module 222. For instance, suppose that a user selects a scenario description associated with a particular scenario solution to execute. As the scenario solution has one or more namespace(s)/keyword(s) with which it is associated, the advertisement identification module 224 may identify enablers that are highly rated (e.g., based upon a user-community rating scheme, a certification by a certifying body, or the like), within the namespace/keyword at random and advertise them to the user. In other embodiments, based upon the user's consent, the advertisement identification module 224 may limit advertisement to the enabler(s) either contained in or not contained in a particular workspace and/or the user's local store, e.g., local information store 218. That is, advertisements for enablers not contained in the user's local store may include advertisements for new enablers that are more highly rated (e.g., based upon a user-community rating scheme, certification, or the like) or related to an enabler to which the user does have access. For instance, if a user's local store contains meta-information about the user's car, the advertisement identification module 224 may identify advertisements for similar cars to the user's car, cars that are more highly rated than the user's car and with a similar price point, a more recent version of the user's car, or the like. On the other hand, the advertisement identification module 224 may also identify advertisements for features of enablers possessed by the user. In this case, the advertisement identification module 224 functions more like a knowledge base of the user but with the difference that the user does not do an explicit search against the knowledge base.

Scenario solutions may also be advertised to the user. For instance, scenario solutions that are related to a scenario solution selected by the user for execution and/or scenario solutions that are higher rated (e.g., based upon a user-community rating scheme, certification, or the like) than a selected scenario solution. Relations between namespaces/keywords can also be deduced by mining highly rated scenario solutions that have a single namespace/keyword as a target and scenario solutions associated with a related namespace/keyword may be identified for presentation.

It should be noted that scenario solutions may also be advertised to scenario solution authors at the time of authoring a scenario solution. In this regard, a scenario solution author may acquire a particular sub-scenario solution to incorporate into their own scenario solution as a sequential sub-scenario solution or may modify an acquired scenario solution to fit his/her own purposes. Any and all such variations are contemplated to be within the scope of embodiments of the present invention.

The transmitting module 226 is configured for transmitting the executable scenario solution related to the scenario-related query and the identified advertisement for presentation, for instance, in association with the end-user device 210. In one embodiment, such presentation may utilize a display device associated with the end-user device 210. Embodiments of the present invention, however, are not intended to be limited to visual display but rather may also include audio presentation, combined audio/video presentation, and the like.

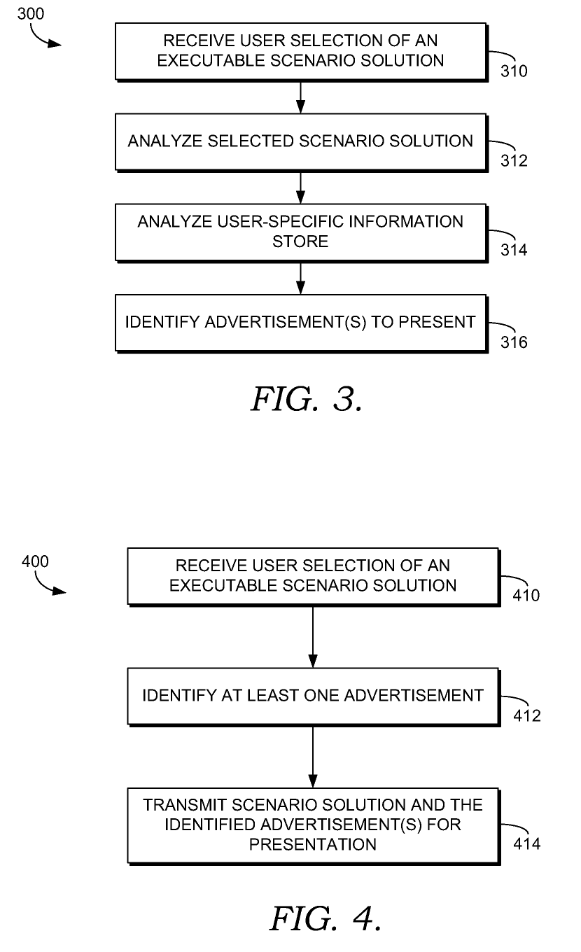

Turning now to FIG. 3, a flow diagram is shown illustrating a method 300 for using scenario-related information to direct advertising, in accordance with an embodiment of the present invention. Initially, as indicated at block 310, user selection of an executable scenario solution is received, e.g., utilizing receiving module 220 of FIG. 2. Typically, the executable scenario solution selected by the user has been previously identified, for instance, by data mining module 222 of FIG. 2, in response to a scenario-related query. Subsequently, as indicated at block 312, the selected scenario solution is analyzed. Prior to, subsequent to, or simultaneously with, analysis of the selected scenario solution, user-specific information stored in association with, for instance, a workspace or a local information store, e.g., local information store 218 of FIG. 2, is analyzed, as indicated at block 314. Subsequently, at least one advertisement is identified utilizing the analyzed metadata, the identified advertisement being relevant to the analyzed information. This is indicated at block 316.

The at least one advertisement identified for presentation may be at least one advertisement related to a frequently executed scenario solution instance associated with the user or a recently executed scenario solution instance associated with a user-specific information store. In embodiments, the advertisement may comprise an executable scenario solution. In other embodiments, the executable scenario solution may comprise a scenario solution having a higher rating, for instance a higher user-community rating or certifying-body certification, than the selected scenario solution. In other embodiments, the advertisement identified for presentation may include an advertisement relevant to an enabler having metadata associated with the user-specific store. In further embodiments, the metadata associated with the user-specific information store may prompt identification of an advertisement that corresponds to an additional enabler that is compatible with an enabler the user already has access to. In any event, the identified advertisement will generally correspond to the scenario solution selected for execution.

Turning now to FIG. 4, a flow diagram is shown illustrating a method 400, for using scenario solution-related information to direct advertising, in accordance with an embodiment of the present invention. Initially, as indicated at block 410, user selection of an executable scenario solution is received. Typically, the executable scenario solution has been identified in response to a scenario-related query. Subsequently, as indicated at block 412, at least one advertisement is identified for presentation, the at least one advertisement being relevant to a user interest. Such user interest may be evidenced by, for instance, metadata associated with the selected scenario solution and/or information associated with a workspace or user-specific information store. Such user interest, and subsequently identified advertisements, may be determined by mining the metadata and other information, e.g., utilizing data mining module 220 of FIG. 2.

As indicated at block 414, a scenario solution for the selected executable scenario solution and the identified advertisement is subsequently transmitted for presentation, for instance, in association with end-user device 210 of FIG. 2.

As can be understood, embodiments of the present invention provide methods, systems, and computer-readable media for directing advertising in search result presentation and/or scenario solution execution based upon a user's locality. “Locality,” as the term is used herein, refers to a collection of metadata created based upon scenario solutions executed by a user and/or enablers acquired by a user during scenario solution execution. For instance, embodiments of the present invention provide a mechanism by which scenario solutions or enablers related to commonly executed scenario solutions or enablers stored in association with the user's locality can be advertised to the user in conjunction with presentation of scenario solution-related search results. Additionally, embodiments of the present invention provide a mechanism by which more highly rated scenario solutions and/or enablers than those associated with the user's locality may be advertised during presentation of an executable scenario solution.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for using scenario solution-related information to direct advertising, the method comprising:
receiving user selection of an executable scenario solution, the executable scenario solution being identified in response to a scenario-related query;
analyzing at least one of metadata associated with the selected scenario solution and metadata associated with a user-specific information store; and
identifying at least one advertisement to present utilizing the analyzed metadata.

2. The one or more computer-readable media of claim 1, wherein the metadata associated with the user-specific information store includes at least one previously executed scenario solution instance.

3. The one or more computer-readable media of claim 2, wherein the metadata associated with the user-specific information store includes metadata that corresponds to at least one enabler acquired during execution of the at least one previously executed scenario solution instance.

4. The one or more computer-readable media of claim 1, wherein the metadata associated with the user-specific information store includes metadata that corresponds to at least one previously acquired enabler.

5. The one or more computer-readable media of claim 1, wherein identifying at least one advertisement to present comprises identifying at least one advertisement relevant to at least one of a frequently executed scenario solution instance and a recently executed scenario solution instance associated with the user-specific information store.

6. The one or more computer-readable media of claim 1, wherein the at least one advertisement comprises an executable scenario solution.

7. The one or more computer-readable media of claim 6, wherein the executable scenario solution comprises a scenario solution having a higher rating than the selected scenario solution.

8. The one or more computer-readable media of claim 1, wherein identifying at least one advertisement to present comprises identifying at least one advertisement relevant to an enabler having metadata associated with the user-specific information store.

9. The one or more computer-readable media of claim 8, wherein the at least one advertisement relevant to the enabler having metadata associated with the user-specific information store comprises an advertisement that corresponds to an additional enabler that is compatible with the enabler.

10. The one or more computer-readable media of claim 8, wherein the at least one advertisement relevant to the enabler having metadata associated with the user-specific information store comprises an advertisement that corresponds to an additional enabler having a higher rating than the enabler.

11. The one or more computer-readable media of claim 1, wherein identifying at least one advertisement to present comprises identifying at least one advertisement that corresponds to the selected scenario solution.

12. A method for using scenario solution-related information to direct advertising, the method comprising:
receiving user selection of an executable scenario solution, the executable scenario solution being identified in response to a scenario-related query;
identifying at least one advertisement to present, wherein the at least one advertisement is relevant to at least one user interest; and
transmitting the selected scenario solution and the at least one identified advertisement for presentation.

13. The method of claim 12, wherein the at least one user interest is evidenced by at least one of metadata associated with the selected scenario solution and metadata associated with a user-specific store, and wherein identifying at least one advertisement to present comprises mining the metadata to determine the at least one user interest.

14. The method of claim 13, wherein identifying at least one advertisement to present comprises identifying at least one advertisement related to at least one of a frequently executed scenario solution and a recently executed scenario solution having metadata associated with the user-specific information store.

15. The method of claim 14, wherein the at least one advertisement comprises an executable scenario solution.

16. The method of claim 13, wherein identifying at least one advertisement to present comprises identifying at least one advertisement that is relevant to an enabler having metadata associated with the user-specific information store.

17. The method of claim 16, wherein the at least one advertisement that is relevant to the enabler having metadata associated with the user-specific information store comprises an advertisement that corresponds to an additional enabler that is compatible with the enabler.

18. The method of claim 16, wherein the at least one advertisement that is relevant to the enabler having metadata associated with the user-specific information store comprises an advertisement that corresponds to an additional enabler having a higher rating than the enabler.

19. A computerized system for using scenario solution-related information to direct advertising, the system comprising:
an end-user device configured for receiving a scenario-related query; and
a server configured for receiving the scenario-related query from the end-user device and identifying at least one advertisement relevant to a user interest to present, wherein the end-user device and the server are in communication with one another via a network.

20. The computerized system of claim 19, wherein the server comprises:
a receiving module configured for receiving the scenario-related query from the end-user device;
a data mining module configured for mining at least one of metadata associated with an executable scenario solution related to the scenario-related query and metadata associated with a user-specific information store;
an advertisement identifying module configured for identifying at least one advertisement to present, wherein the at least one advertisement is identified based upon the mined metadata; and
a transmitting module configured for transmitting the executable scenario solution related to the scenario-related query and the identified advertisement for presentation in association with the end-user device.
